(19) United States
(12) Patent Application Publication
(10) Pub. No.: US 2025/0104259 A1
(43) Pub. Date: Mar. 27, 2025

(54) METHOD AND DEVICE WITH DEPTH MAP ESTIMATION BASED ON LEARNING USING IMAGE AND LIDAR DATA

(71) Applicant: Samsung Electronics Co., Ltd., Suwon-si (KR)

(72) Inventors: Hyeongseok SON, Suwon-si (KR); Seungin PARK, Suwon-si (KR); Byung In YOO, Suwon-si (KR); Dongwook LEE, Suwon-si (KR); Sangil JUNG, Suwon-si (KR)

(73) Assignee: Samsung Electronics Co., Ltd., Suwon-si (KR)

(21) Appl. No.: 18/631,836

(22) Filed: Apr. 10, 2024

(30) Foreign Application Priority Data
Sep. 21, 2023 (KR) 10-2023-0126512

(51) Int. Cl. G06T 7/50; G06T 5/20; G06T 7/12

(52) U.S. Cl. CPC G06T 7/50; G06T 5/20; G06T 7/12; G06T 2207/10028; G06T 2207/20081

(57) ABSTRACT

A method performed by one or more processors of an electronic device includes: processing an input image and point cloud data corresponding to the input image; projecting the point cloud data to generate a first depth map and adding new depth values to the first depth map based on the input image; obtaining a second depth map by inputting the input image to a depth estimation model configured to infer depth maps from input images; and training the depth estimation model based on a loss difference between the first depth map and the second depth map.

### CROSS-REFERENCE TO RELATED APPLICATIONS

This application claims the benefit under 35 USC § 119(a) of Korean Patent Application No. 10-2023-0126512, filed on Sep. 21, 2023, in the Korean Intellectual Property Office, the entire disclosure of which is incorporated herein by reference for all purposes.

### BACKGROUND

### 1. Field

The following description relates to a method and device with depth map estimation based on self-supervised learning by using an image and lidar data.

### 2. Description of Related Art

Neural networks are generally used to estimate depths of pixels in images. Such a neural network model (for estimating the depths of pixels from an image) may be trained with training data having training input pairs; each training input pair consisting of a training input (e.g., a training image) and a ground-truth training output (e.g., a ground-truth depth map corresponding to the training image) associated with the training input. For example, the neural network model may be trained so as to infer, from a training input, an output that is close to a ground-truth training output that is paired with the training input. More specifically, training of the neural network model may involve generating/inferring a temporary output in response to the training input and then updating (e.g., adjusting weights) of the neural network model to minimize a loss between the temporary output and the training output. In this case, a training image and a ground-truth depth map corresponding to the training image are required as the training data for training the neural network model. However, it may be difficult to obtain sufficient training data of this nature due to expenses of generating a ground-truth depth map corresponding to a training image.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device includes one or more processors and memory storing instructions configured to cause the one or more processors to: process an input image and point cloud data corresponding to the input image; generate a first depth map by projecting the point cloud and determining some depth values of first depth map based on the input image; obtain a second depth map by inputting the input image to a depth estimation model configured to generate depth maps from images; train the depth estimation model based on a loss between the first depth map and the second depth map; and generate a final depth map corresponding to the input image through the trained depth estimation model.

The instructions may be further configured to cause the one or more processors to generate the first depth map by projecting the point cloud data to form a depth image and transform the depth image to the first depth map based on the input image.

The instructions may be further configured to cause the one or more processors to transform the depth image to the first depth map by applying a first image filter based on the input image to the depth image.

The instructions may be further configured to cause the one or more processors to generate a semantic segmentation image by performing semantic segmentation on the input image, and transform the depth image to the first depth map by applying a second image filter based on the semantic segmentation image to the depth image.

The instructions may be further configured to cause the one or more processors to calculate the loss based on differences between depth values of pixels in the first depth map and depth values of corresponding pixels in the temporary depth map and update a parameter of the depth estimation model by backpropagating the calculated loss from an output layer of the depth estimation model to an input layer of the depth estimation model.

The instructions may be further configured to cause the one or more processors to repeatedly update the parameter of the depth estimation model based on repeated inputting of the input image to the depth estimation model.

The repeated inputting may be performed until it is determined that a corresponding loss between the first depth map and second depth maps obtained by the repeated inputting of the input image to the depth estimation model is less than a threshold loss.

The repeated inputting of the input image to the depth estimation model may be terminated based on the repeated inputting reaching a preset iteration limit.

The instructions may be further configured to cause the one or more processors to train the depth estimation model by using the input image and one or more frame images adjacent to the input image within a video segment.

The instructions may be further configured to cause the one or more processors to generate point cloud information based on the input image and the final depth map corresponding to the input image and perform object detection by using the generated point cloud information.

In another general aspect, a method performed by one or more processors of an electronic device includes: processing an input image and point cloud data corresponding to the input image; projecting the point cloud data to generate a first depth map and adding new depth values to the first depth map based on the input image; obtaining a second depth map by inputting the input image to a depth estimation model configured to infer depth maps from input images; and training the depth estimation model based on a loss difference between the first depth map and the second depth map.

The added depth values may be computed based on color values of the input image.

The method may further include applying a first image filter based on the input image to the first depth map.

The generating of the first depth map may further include: generating a semantic segmentation image by performing semantic segmentation on the input image; and forming the first depth map by applying a second image filter based on the semantic segmentation image to the first depth map.

The training of the depth estimation model may include: calculating the loss difference based on a difference between a depth value of a pixel in the first depth map and a depth value of a corresponding pixel in the second depth map; and updating a parameter of the depth estimation model based on the difference.

The training of the depth estimation model may include: repeatedly updating parameters of the depth estimation model based on repeated inputting of the input image to the depth estimation model.

The repeated updating of the parameter of the depth estimation model may be terminated based on determining that a loss between the temporary depth map obtained by the repeated inputting the input image to the depth estimation model and the first depth map is less than a threshold loss.

The repeated updating of the parameters of the depth estimation model may be terminated based on the repeated inputting of the input image to the depth estimation model being performed a preset number of times.

The method may further include training the depth estimation model by using the input image and one or more frame images adjacent to the input image in a video segment.

The method may further include generating point cloud information based on the input image and the final depth map corresponding to the input image and performing object detection by using the generated point cloud information.

Other features and aspects will be apparent from the following detailed description, the drawings, and the claims.

### BRIEF DESCRIPTION OF THE DRAWINGS

FIG. 1 illustrates an example of estimating a depth map by using an input image and lidar data in an electronic device, according to one or more embodiments.

FIG. 2 illustrates an example electronic device, according to one or more embodiments.

FIG. 3 illustrates the accuracy of an example final depth map generated by the electronic device, according to one or more embodiments.

FIG. 4 illustrates an example of a pseudo depth map generated by the electronic device, according to one or more embodiments.

FIG. 5 illustrates an example of generating a final depth map corresponding to an input image by using the input image or other images of an adjacent frame, according to one or more embodiments.

FIG. 6 illustrates an example of generating a point cloud by using a final depth map corresponding to an input image, according to one or more embodiments.

FIG. 7 illustrates an example of performing object detection by using a point cloud, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

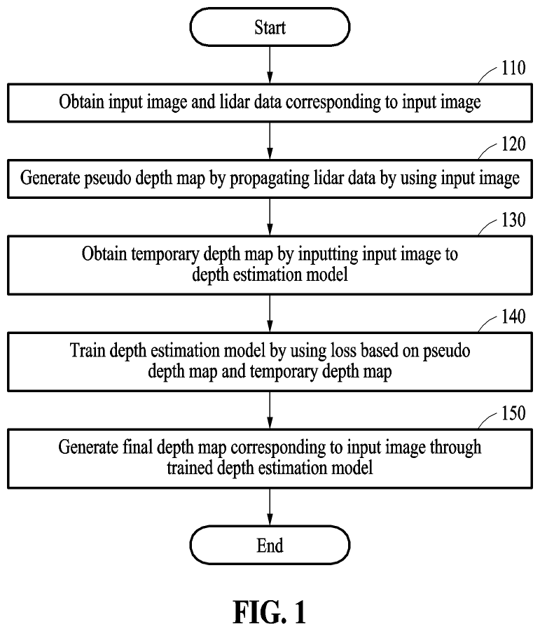

FIG. 1 illustrates an example of estimating a depth map by using an input image and lidar data in an electronic device, according to one or more embodiments.

The electronic device according to some embodiments may estimate a dense depth map (hereinafter, the “depth map”) for the input image by using the input image and lidar data corresponding to the input image. The term “dense” refers to the opposite of a sparse depth map and generally refers to depth maps that are generally complete for a scene/image but which may have holes (blind spots) or small areas of density (e.g., light density). The input image may be, for example, a color image in which each pixel has a red, green, and blue (RGB) value. The input image may also be a grayscale image, e.g., an image as might be captured by an infrared camera. The estimated depth map may include depth values estimated for each of the respective pixels in the input image. The number of pixels of the estimated depth map may be the same as the number of pixels of the input image (at least in spatial dimension; the input image may have multiple color values per pixel). However, examples are not limited to the foregoing example.

Regarding estimating the depth map, the electronic device according to some embodiments may estimate the depth map without necessarily needing to use more than the input image and the lidar data (point cloud, possibly sparse). Without needing to use a highly accurate ground truth that has been prepared in advance, the electronic device may generate ground truth data (e.g., a ground truth depth map) corresponding to the input image by itself. The highly accurate ground truth may be obtained through manual work (e.g., manual labeling) by experts. As described below, the electronic device may estimate a ground truth depth map from the input image and may prepare a data set including the input image and the estimated ground truth depth map. The electronic device may train (e.g., additionally train) a depth estimation model by using the data set (e.g., a self-made data set) prepared by itself. The depth estimation model may be a machine-learning model that has been pre-trained for depth estimation. The pre-trained machine-learning model may be configured and trained to output a depth map from an image of a generic vision sensor (e.g., a generic camera sensor). In a result depth map of the pre-trained machine-learning model, the shape formed by depth values may be accurate. However, when the image that used is an image captured by another camera sensor having parameters different from the parameters of the vision sensor that is assumed in the pre-trained machine-learning model (e.g., the generic camera sensor), depth values corresponding to a random/arbitrary shape may appear in relatively moved positions in the result depth map of the pre-trained machine-learning model. The depth estimation model (e.g., the pre-trained machine learning model) may be fine-tuned through additional training using the self-made data set described above. This additionally trained depth estimation model may be fine-tuned (as per the additional training) to output a result specialized for the parameters (e.g., internal parameters, external parameters, a posture) of a camera sensor that has captured the input image of the data set used for the additional training. The electronic device may apply the input image to the additionally trained (or fine-tuned) depth estimation model and may generate a final depth map. The final depth map may include depth values more accurate than the depth values of the ground truth depth map estimated from the input image and in positions more accurate than the result of the pre-trained machine-learning model. Accordingly, the electronic device according to an embodiment may output an accurate final depth map by using the depth estimation model as fine-tuned by using the ground truth data (e.g., the ground truth depth map) generated by itself without manual work. Hereinafter, estimating the depth map (e.g., the final depth map) corresponding to the input image by the electronic device is described in more detail.

Referring to FIG. 1, in operation 110, the electronic device may obtain the input image and lidar data (possibly sparse) corresponding to the input image. The input image may be an image generated by a camera (e.g., RGB and/or infrared). A point cloud generated by a lidar sensor may be obtained as the lidar data. However, examples are not limited to the foregoing example, and the electronic device may receive the input image and the lidar data corresponding to the input image from an external device. Furthermore, the point cloud may be generated by any suitable type of sensor or other source; the means of generating the point cloud is not significant so long as the point cloud can accomplish sufficient results. With that in mind, reference to “lidar data” herein, depending on the context, refers to point cloud data obtained by any means.

In operation 120, the electronic device may generate a pseudo depth map by using the input image to effectively extend or propagate the lidar data. This operation is described in detail later.

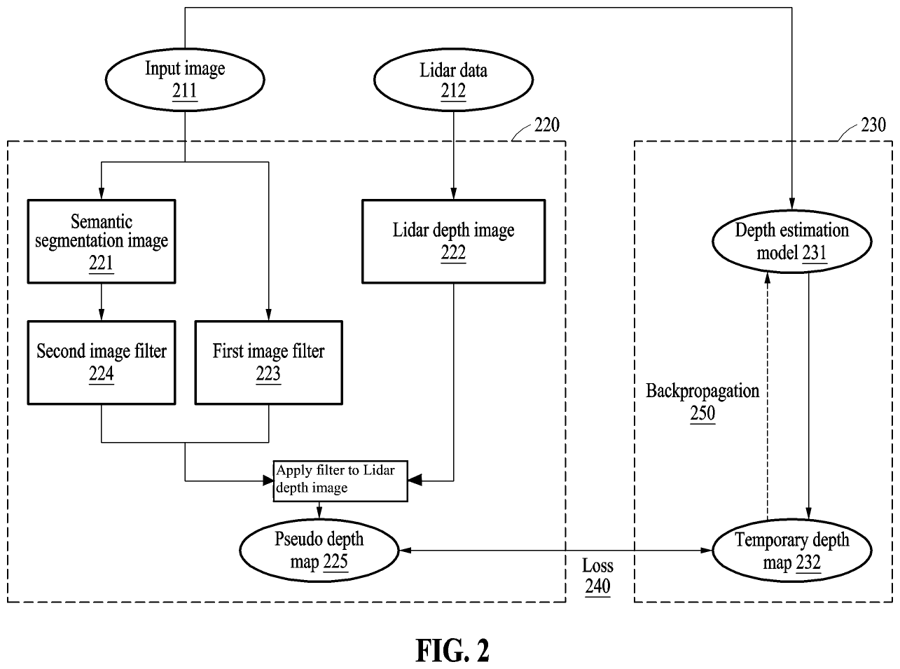

In an example, the electronic device may generate a lidar-based depth image by projecting the lidar data (the point cloud map) onto an image (e.g., taking a two-dimensional projection, see the lidar depth image 222 in FIG. 2). For example, the coordinates of each point (e.g., a three-dimensional point) of the point cloud map may be three-dimensional coordinates in a lidar coordinate system. The lidar coordinate system may be a three-dimensional world coordinate system, in which the points of the point cloud map obtained by the lidar sensor are expressed, and may be a coordinate system having any position (e.g., the position of the lidar sensor) as an origin point. The coordinates of each point of the point cloud map may be transformed into coordinates (e.g., the coordinates of a pixel position) in a camera coordinate system and/or an image coordinate system corresponding to a camera sensor through camera parameters (e.g., the camera's internal parameters and the camera's external parameters). The projection of the lidar data onto the image may include the operation of transforming the coordinates of each point of the lidar data into coordinates in the image coordinate system. The projection of the lidar data may also include, in addition to the coordinate transformation described above, the operation of mapping a depth value to a three-dimensional point corresponding to a transformed pixel position to a corresponding pixel position. Accordingly, the lidar-based depth image may include the depth values from a view of the camera sensor to the three-dimensional points of the lidar data. The resulting projected lidar-based depth image may be sparse due to sparsity of the lidar data (point cloud). That is, the lidar-based depth image may have pixels that lack depth values. The electronic device may apply an image filter (e.g., an edge-aware filter) based on the input image to the lidar-based depth map described above and may thus generate the pseudo depth map. For example, the electronic device may transform the lidar-based depth map into the pseudo depth map by using the input image-based edge-aware filter. For example, the input image-based image filter may transform a sparse depth map (lidar-based depth image) into a dense depth map. In this case, dense depth map may serve as the pseudo depth map. As described below, a guided image filter that uses the input image as a guidance image is mainly described herein as an example of the edge-aware filter. For reference, the operation of applying the edge-aware filter may be referred to herein as filtering or image filtering.

In operation 130, the electronic device may obtain a temporary depth map by inputting the input image to a depth estimation model, the depth estimation model may be a machine learning model pre-trained with training data. The training data for pre-training may include a training image and a training depth map corresponding to the training image. The depth estimation model may be a model that is configured and trained to output the training depth map from the training image. For reference, the training depth map of the training data for pre-training may be different from the ground truth depth map (e.g., the pseudo depth map obtained through the projection of operation 120 described above and the guided-image filtering of operation 130) generated by itself for fine-tuning herein. The training data may be a data set (e.g., an external data set) that has been separately prepared in advance, and the training depth map may be, for example, a map having depth values that are manually labeled by experts.

In operation 140, the electronic device may train the depth estimation model by using a loss between the pseudo depth map and the temporary depth map. In an example, the electronic device may calculate the loss based on differences between pixel values of the pseudo depth map and respectively corresponding pixel values of the temporary depth map and may update parameters (e.g., weights) of the depth estimation model, based on the calculated loss. Accordingly, the depth estimation model may be fine-tuned by using the pseudo depth map (generated by itself through operations 120 and 130 described above) as the ground truth depth map.

In an example, the electronic device may repeatedly update the parameters of the depth estimation model by a preset number of times. The electronic device may repeatedly update the parameters of the depth estimation model based on repeated inputting of the input image to the depth estimation model by a preset number of times.

In operation 150, the electronic device may generate a final depth map for the input image through the trained depth estimation model. For example, the electronic device may input the input image to the depth estimation model (of which the training has been completed) and may perform inference on the input image and the output from the depth estimation model may be set as the final depth map for the input image. However, examples are not limited to the foregoing example. For another example, the electronic device may determine the temporary depth map inferred in the last iteration of additional training for the fine-tuning of operation 140 to be the final depth map.

FIG. 2 illustrates an example of the electronic device, according to one or more embodiments.

In an example, the electronic device may include a pseudo labeling unit 220 and a depth estimation unit 230. The “pseudo” of the pseudo labeling unit 220 refers to the fact that input data may be labeled with ground truth data that is pseudo data. For example, ground truth data may include pseudo (estimated) depth data.

In an example, the pseudo labeling unit 220 of the electronic device may receive an input image 211 and lidar data 212. The pseudo labeling unit 220 may propagate the lidar data 212 by using an edge-aware filter based on the input image 211 and may generate a pseudo depth map 225.

In an example, the pseudo labeling unit 220 may generate a lidar depth image 222 by projecting the lidar data 212 (point cloud map) onto an image. For example, the lidar data 212 may include coordinates of three-dimensional (3D) points in a 3D space. The pseudo labeling unit 220 may generate the lidar depth image 222 by aligning individual 3D points in the lidar data 212 with pixels of an image coordinate system. For example, the electronic device may transform the 3D coordinates of the 3D points of the lidar data 212 into 2D coordinates in an image coordinate system corresponding to a camera by using the camera parameters (e.g., the camera's external parameters) of the camera. The camera's external parameters may be parameters indicating a transformation relationship between a camera coordinate system and a world coordinate system (e.g., a lidar coordinate system), which may be rotation transformation and translation transformation between the camera coordinate system and the world coordinate system. Among the camera's external parameters, a matrix indicating the rotation transformation may be referred to as a rotation matrix and a matrix indicating the translation transformation may be referred to as a translation matrix.

The lidar depth image 222 may be a depth map including pixels having respective depth values in an image plane that is the same as an image plane of the input image 211. A pixel of the lidar depth image 222 may have a depth value (or a distance value) to a corresponding 3D point. As described above, since the 3D points of the lidar data 212 are projected onto the respective pixel positions of the pixels of the lidar depth image 222, a 3D point may correspond to a pixel position in the lidar depth image 222. A pixel value (e.g., a depth value) of any pixel position in the lidar depth image 222 may be a value indicating a distance (e.g., a depth) to a corresponding 3D point from a reference position (e.g., a camera position). However, not all pixels of the lidar depth image 222 have a depth value, and the depth value may not be determined for some pixels because the corresponding lidar data 212 is sparse. A point cloud is a set of points in a 3D space. The lidar data 212 may include information on only some points in the 3D space; not necessarily information on all points in the 3D space (the point cloud may be sparse or empty in some regions). That is to say, the lidar depth image 222 generated by projecting the lidar data 212 onto the image may be a sparse depth map. The pseudo labeling unit 220 may use the input image 211 to update (fill out) the possibly-sparse lidar depth image 222, to form the pseudo depth map 225, which is a dense depth map. In other words, the pseudo labeling unit 220 may generate the pseudo depth map 225 by updating the lidar-based depth image 222 based on the input image 211 (as described below). The process of generating the pseudo depth map 225, which is the dense depth map, by the pseudo labeling unit 220 is described next.

The pseudo labeling unit 220 may use the lidar depth image 222 as a source image to propagate (extend/use) the depth information in the lidar data 212. The pseudo labeling unit 220 may use an edge-aware filter. The edge-aware filter may be a filter that smoothens small details while retaining the structural edges of an image. The edge-aware filter may be applied to a lidar-based depth image. The edge-aware filter may include a joint bilateral filter and/or a guided image filter. The guided image filter is a main non-limiting example used to describe the edge-aware filter herein. The pseudo labeling unit 220 may apply a guided image filter (which is based on the input image 211) to the lidar-based depth image. The guided image filter may be a filter that refers to an image (e.g., a guidance image) given as filtering guidance. The guided image filter removes noise (e.g., high-frequency components) in a source image (e.g., the lidar depth image 222) by smoothening the remaining parts, while retaining parts having an edge that is similar to an edge of the guidance image. The electronic device may perform guided image filtering (based on the guidance image) on the source image and may thus generate a result image. For example, the electronic device may determine patches corresponding to one another by respectively sweeping a local window with respect to the source image and the guidance image. Regarding this technique, a patch corresponding to the local window in the source image may be referred to as a source patch and a patch corresponding to the local window in the guidance image may be referred to as a guidance patch. In an example using the guided image filter, the respective pixel values of the source patch and the guidance patch may be modeled as shown below.

$${q}_{i} = {p}_{i} - {n}_{i} \qquad Equation 1$$

$${q}_{i} = {aI}_{i} + b \qquad Equation 2$$

In Equations 1 and 2, qᵢ denotes an i-th pixel value in a corresponding patch (e.g., a result patch) in an ideal result image not including noise. i is an integer greater than or equal to 1. pᵢ denotes an i-th pixel value of a source patch including noise. nᵢ denotes a noise component included in an i-th pixel in the source patch. lᵢ denotes an i-th pixel value in a guidance patch. a and b denote coefficients of a linear relationship formed between the i-th pixel value lᵢ of the guidance patch and the i-th pixel value qᵢ of the result patch. Since Equations 1 and 2 are modeled for the same local window, a relationship between Equations 1 and 2 may be approximately integrated as expressed by Equation 3.

$${p}_{i} \approx a {I}_{i} + b \qquad Equation 3$$

Accordingly, a least square problem derived from the relationship according to Equation 3 is represented by Equation 4, and the coefficients a and b calculated through linear regression from Equation 4 are represented by Equation 5.

$${min}_{a , b} {\sum }_{i} {( {aI}_{i} + b - {p}_{i} )}^{2} + ϵ {a}^{2} \qquad Equation 4$$

$$a = \frac{cov ( I , p )}{var ( I ) + ϵ} b = \overline{p} \to a \overline{I} \qquad Equation 5$$

In Equation 5, cov(I,p) denotes a covariance between a source patch p and a guidance patch I, var(I) denotes a variance of the guidance patch I, and ∈ denotes a regularization term used to set the coefficient a to be small. p̅ denotes an average value of the source patch p and Ī denotes an average value of the guidance patch I. The electronic device may determine the coefficients a and b indicating a linear transformation forming a result patch q where noise is removed from the guidance patch I by pixels by patches through Equation 5 shown as an example.

The electronic device may apply a linear transformation from a guidance patch (e.g., the guidance image) into a result patch (e.g., a result image) to a source patch (e.g., a source image) and may perform guided image filtering based on the guidance image on the source image. For example, the guidance image may be the input image 211 (e.g., an image captured by a camera sensor) and the source image may be the lidar-based depth image (e.g., the lidar depth image 222). For example, there may not be depth values for some of the pixels in the lidar depth image 222, which is the sparse depth map. For example, the pixels not having depth values (among the pixels of the lidar depth image 222) may be padded to have a default depth value (e.g., a value of 0). The pixels padded to have the value of 0 may seem like noise compared to surrounding pixels. As described above, the guided image filter may be used for calculating depth values of pixels in the source image under the assumption that depth values of pixels included in a same object detected in the guidance image (e.g., the input image 211) are similar to one another. The electronic device may apply a linear transformation (e.g., the linear transformation using the coefficients a and b according to Equation 5 above) from a patch (e.g., an input patch) of the input image 211 into a patch (e.g., a pseudo depth patch) of a result image (e.g., a pseudo depth map) to a patch (e.g., a lidar-based depth patch) of the lidar depth image 222 and may thus generate the pseudo depth patch. Pixels, which correspond to a part not having a depth value among the lidar-based depth patch, in the pseudo depth patch may have a pixel value to which surrounding pixel values are propagated by the guided image filtering described above. For example, the pixels having padded values may be understood to include noise components but may have pixel values from which noise is removed through the guided image filtering described above. The electronic device may perform the guided image filtering on the lidar depth image 222 by referring to the input image 211 as the guidance image and may generate the pseudo depth map 225 as the result image. For reference, the guided image filter using the input image 211 as the guidance image may be referred to as a first image filter 223 herein. The applying of the first image filter 223 (or an operation using the first image filter 223) may be referred to as first image filtering. The applying of the first image filter 223 to the lidar depth image 222 may be a linear transformation of the lidar depth image 222 into the pseudo depth map 225 by using a first linear transformation coefficient (e.g., the coefficient a or b) determined for each local window through the linear regression described above, based on the input image 211.

However, examples are not limited to the foregoing examples. The pseudo labeling unit 220 may also use a semantic image (e.g., a semantic segmentation image 221), which is generated by applying semantic segmentation to the input image 211, as a guidance image for a guided image filter. The pseudo labeling unit 220 may generate a semantic segmentation image 221 by performing semantic segmentation on the input image 211. The semantic segmentation may be an algorithm for classifying pixels of an image, usually by defining regions where pixels have a same classification. The pseudo labeling unit 220 may generate the semantic segmentation image 221 (which classifies sets of pixels of the input image 211 into respective classes (and generally, corresponding bounded regions)) by performing semantic segmentation on the input image 211. Any segmentation algorithm may be used, for example, object detection algorithms, foreground-background segmentation, combinations of segmentation algorithms, etc. The pseudo labeling unit 220 may perform guided image filtering on the lidar depth image 222 by referring to the semantic segmentation image 221 as the guidance image and may generate the pseudo depth map 225 as the result image. For example, an object segmentation image indicating a part corresponding to an object through semantic segmentation from the input image 211 may be generated as the semantic segmentation image 221. When the lidar depth image 222 only includes depth values for some of the part corresponding to the object, the depth values for some of the part may be propagated to the remaining part of the object through the guided image filtering, which refers to the object segmentation image described above as the guidance image, and the depth values of the remaining part of the object may thus be filled. For example, the guided image filter using the semantic segmentation image 221 as the guidance image may be referred to herein as a second image filter 224. Like the first image filter 223, the second image filter 224 may be used under the assumption that depth values of pixels classified into the same class in the semantic segmentation image 221 are similar to one another. The applying of the second image filter 224 (or an operation using the second image filter 224) may be referred to herein as second image filtering. The applying of the second image filter 224 to the lidar depth image 222 may be a linear transformation of the lidar depth image 222 into the pseudo depth map 225 by using a second linear transformation coefficient (e.g., the coefficient a or b) determined for each local window through the linear regression described above, based on the semantic segmentation image 221. Since the second image filter 224 refers to the semantic segmentation image 222 as its guidance image, a boundary between foreground and background and a boundary between an object and another object are highlighted/emphasized. Thus, the second image filter 224 may provide more accurate depth values in each object unit than the first image filter 223 using the input image 211.

According to an embodiment, the electronic device may selectively apply the first image filter 223 or the second image filter 224. For example, the electronic device may perform semantic segmentation and an operation according to the second image filter 224 when a measure of available resources (e.g., computing power, power, or memory) exceeds a threshold. The electronic device may perform an operation according to the first image filter 223 when the measure of available resources is less than or equal to the threshold. However, examples are not limited thereto. The electronic device may use the second image filter 224 in an environment requiring high accuracy and may use the first image filter 223 in an environment requiring low accuracy. The electronic device may use the first image filter 223 in an environment, such as a rural area, where the small number of objects appear in a monotonous pattern. However, the foregoing examples are non-limiting and are provided to enhance understanding and are not intended to limit the situations in which the first image filter 223 or the second image filter 224 is used.

As noted above, the depth estimation unit 230 of the electronic device may receive the input image 211. The depth estimation unit 230 may also store a depth estimation model 231, or more specifically, parameters (e.g., weights, connections, biases, etc.) of the depth estimation model 231. The depth estimation model 231 may be a machine learning model (e.g., a neural network) that has been pre-trained through training data consisting of a training image and a ground-truth depth map corresponding to the training image. The depth estimation unit 230 may perform fine-tuning (e.g., additionally update the parameters) on the depth estimation model 231 to calculate a final depth map corresponding to the input image 211.

The depth estimation unit 230 may input the input image 211 to the depth estimation model 231. The depth estimation model 231 may, by inferencing on the input image 211, output a temporary depth map 232 based on the input of the input image 211. The depth estimation unit 230 may calculate a loss based on the pseudo depth map 225 generated from the pseudo labeling unit 220 and the temporary depth map 232. The depth estimation unit 230 may train the depth estimation model 231 based on the calculated loss (e.g., using backpropagation techniques).

In an example, the depth estimation unit 230 may calculate a loss 240 based on differences between values (e.g., depth values) of pixels corresponding to each other in the pseudo depth map 225 and the temporary depth map 232. For example, the depth estimation unit 230 may calculate, as the loss 240, a sum (e.g., L1 distance) of the depth value differences. The depth estimation unit 230 may update the parameter of the depth estimation model 231 through operation 250 of backpropagating the calculated loss 240 from an output layer of the depth estimation model 231 to an input layer of the depth estimation model 231. The depth estimation model 231 may update the parameters (e.g., connection weights) of the depth estimation model 231 such that the loss 240 may decrease, which may be done in a process of propagating the loss 240 in a reverse direction from a hidden layer to an input layer starting from the output layer.

In an example, the depth estimation unit 230 may repeatedly update the parameters of the depth estimation model 231 based on a repeated input of the same input image 211 to the depth estimation model 231. The inputting and updating may be repeated until a loss between the temporary depth map 232 obtained by inputting the input image 211 to the depth estimation model 231 and the pseudo depth map 225 is less than a threshold loss.

For example, the depth estimation unit 230 may obtain a first temporary depth map by inputting the input image 211 to the depth estimation model 231. The depth estimation unit 230 may determine whether a loss between the inferred first temporary depth map and the pseudo depth map 225 is less than the threshold loss. The depth estimation unit 230 may calculate the loss based on value differences (e.g., depth value differences) of pixels corresponding to each other in the first temporary depth map and the pseudo depth map 225.

When the loss between the first temporary depth map and the pseudo depth map 225 is less than the threshold loss, the depth estimation unit 230 may update the parameter of the depth estimation model 231 one last time by backpropagating the loss between the first temporary depth map and the pseudo depth map 225 to the depth estimation model 231, and then may terminate the update of the parameter of the depth estimation model 231.

However, when the loss between the first temporary depth map and the pseudo depth map 225 is greater than or equal to the threshold loss, the depth estimation unit 230 may update the parameter of the depth estimation model 231 (by backpropagating the loss between the first temporary depth map and the pseudo depth map 225 to the depth estimation model 231) and then may continue performing the updating of the parameters of the depth estimation model 231. That is, the depth estimation unit 230 may obtain a second temporary depth map by inputting the input image 211 to the depth estimation model 231 in which the parameters have just been updated. The depth estimation unit 230 may then determine whether the loss between the second temporary depth map and the pseudo depth map 225 is less than the threshold loss, and so on.

The depth estimation unit 230 may repeatedly update the parameters of the depth estimation model 231 (as described above) up to a preset maximum number (e.g., N) of times. In other words, the depth estimation unit 230 may preset the number of updates of the depth estimation model 231 and may repeatedly input the input image 211 to the depth estimation model 231 by the preset number. In some examples, updating may be stopped as soon as the loss is below the threshold and the max-N number of iterations may prevent infinite updating.

The depth estimation unit 230 may input the input image 211 to the depth estimation model 231 of which training is completed and may obtain output data of the depth estimation model 231 as the final depth map corresponding to the input image 211. For reference, a temporary depth map that is estimated in the last iteration of training for fine-tuning may be used as the final depth map. For another example, the electronic device may perform inference on another input image by using the depth estimation model 231 of which the training for fine-tuning has been completed. The other input image may be an image of a time frame subsequent to a time frame of the input image 211 used for the training for fine-tuning described above.

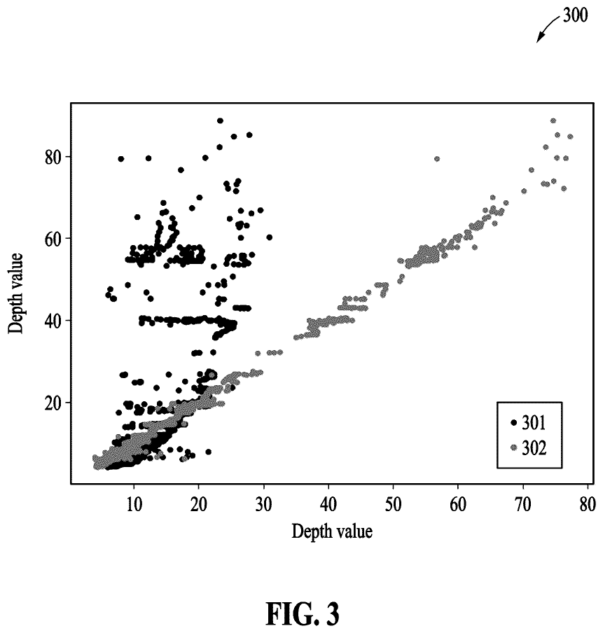

FIG. 3 illustrates the accuracy of an example of a final depth map generated by the electronic device, according to one or more embodiments.

Referring to FIG. 3, a y-axis of graph 300 shows a pixel value (or the depth value) of the lidar points included in the lidar depth image. An x-axis of graph 300 shows the depth value of the lidar points estimated through a depth estimation model.

The points displayed in a first shade 301 in graph 300 indicate results estimated by inputting a random image to a depth estimation model trained according to a comparative embodiment (e.g., a depth estimation model that has not been fine-tuned as described herein). The points displayed with the first shade 301 in graph 300 have, as an x-axis value, depth values estimated of a final depth map obtained by inputting an input image to a depth estimation model trained according to a comparative embodiment, which may be the same type of model as the depth estimation model 231 described above (but trained with different data). In this case, the individual pieces of training data used to train the model include training images paired with respectively corresponding ground-truth depth maps (which may or may not be lidar-based).

The points displayed in a second shade 302 in graph 300 indicate results estimated by inputting the same image to the depth estimation model 231 trained (e.g., fine-tuned) according to one or embodiments described herein. The points displayed in the second shade 302 in graph 300 may have depth values in the x-axis direction obtained by inputting the same input image to a depth estimation model 231 trained (fine-tuned) with training data from the pseudo labeling unit 220.

The y-axis of FIG. 3 represents a depth value of each lidar point of a lidar-based depth image projected from lidar data on a scene corresponding to a common image input to each depth estimation model. The results estimated according to an embodiment described herein may be aligned with positions corresponding to depth values of lidar points on the y-axis of the graph and depth values estimated through the depth estimation model 231 (according to one or more embodiments) on the x-axis. The results estimated according to a comparative embodiment may be aligned with positions corresponding to the depth values of the lidar points on the y-axis of the graph and depth values estimated through the depth estimation model according to a comparative embodiment on the x-axis. As described above, since the same image and the same lidar-based depth image are used, the results estimated according to an embodiment and the results estimated according to a comparative embodiment may have the common depth values on the y-axis. In other words, graph 300 show a level at which the estimated results of each depth estimation model may match the depth values of the lidar-based depth image. The depth values estimated by the depth estimation model 231 according to an embodiment may have a more linear relationship with the depth values of the lidar-based depth image than the depth values estimated by the depth estimation model according to a comparative embodiment. Accordingly, the depth estimation model 231 according to an embodiment may output more accurate depth values from the image than the depth estimation model according to a comparative embodiment.

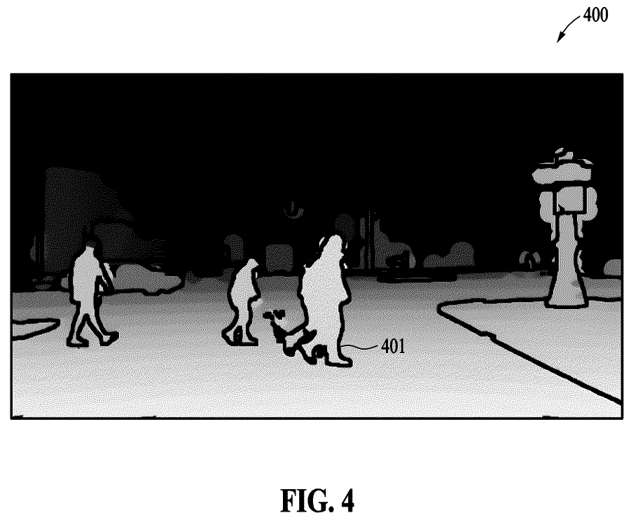

FIG. 4 illustrates an example of a pseudo depth map 400 generated by the electronic device, according to one or more embodiments. The shades in the pseudo depth map 400 represent depths.

In an example, the electronic device may generate a pseudo depth map (e.g., the pseudo depth map 225 of FIG. 2) by using an input image (e.g., the input image 211 of FIG. 2) and lidar data (e.g., the lidar data 212 of FIG. 2) or point cloud data of any variety. The pseudo depth map 400 an example of one that may be generated by the electronic device may by propagating (extending/filling/interpolating) the lidar data by using the edge-aware filter (e.g., the guided image filter).

In an example, the electronic device may generate a lidar-based depth image by projecting the lidar data (or other type/source of point cloud data) onto an image. The lidar-based depth image (depth map) may be sparse, that is, it may have areas where depth data is sparse or missing. Such sparsity may arise as a result of sparsity in the lidar data and/or from projecting any volume of 3D points to a 2D image. To remove an artifact caused when using the sparse depth map (fill out sparse area(s)), the sparse depth map may be transformed into a dense depth map.

For example, the electronic device may perform first image filtering (e.g., filtering using the first image filter 223), which refers to the input image as a guidance image, on lidar-based depth image. As described above, the first image filtering may be filtering under the assumption that pixels of the lidar-based depth image corresponding to pixels having similar pixel values (e.g., RGB values) among pixels in the input image have similar depth values.

For another example, the electronic device may perform second image filtering (e.g., filtering using the second image filter 224), which refers to a semantic segmentation image as the guidance image, on the lidar-based depth image. Likewise, the second image filtering may be filtering under the assumption that the pixels of the lidar-based depth image corresponding to pixels having similar pixel values (e.g., semantic values) among pixels in the semantic segmentation image have similar depth values. For reference, the electronic device may generate the semantic segmentation image by performing semantic segmentation on the input image.

In an example, the electronic device may generate the pseudo depth map 400 (a dense depth map some of whose depth values are synthetic/inferred) by using the first or second image filter to propagate depth values in the lidar-based depth map (a sparse depth map) to surrounding pixels (or surrounding points). In other words, the electronic device may generate the pseudo depth map 400 by applying the first image filter or the second image filter to the lidar depth map to generate some new depth values in the pseudo depth map 400.

In an example, the electronic device may train a depth estimation model (e.g., the depth estimation model 231 of FIG. 2) by using the pseudo depth map 400 and a temporary depth map (e.g., the temporary depth map 232 of FIG. 2). Because the pseudo depth map 400 may have depth data that is superior to the lidar-based depth image 222, training with the pseudo depth map 400 will make it less likely that an error will be caused at pixels corresponding to an object boundary 401 in the pseudo depth map 400, the electronic device may perform masking on the pixel such that the pixel is not used for training. More specifically, the electronic device may perform object detection on the input image or the semantic segmentation image and may apply boundary information of a detected object to the pseudo depth map 400. For example, algorithms, such as a region-based convolutional neural network (R-CNN) or you only look once (YOLO) algorithm, may be used for object detection.

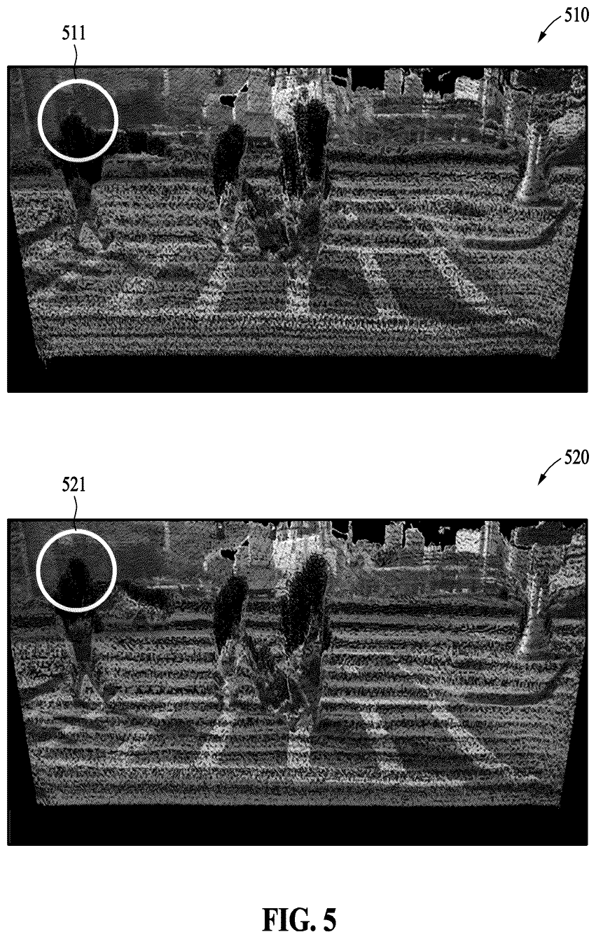

FIG. 5 illustrates an example of generating a final depth map corresponding to an input image by using the input image or other images of an adjacent frame, according to one or more embodiments.

In the example, the electronic device receives an input video that includes multiple frame images. The input image may be one of these frame images. The electronic device may also receive lidar data corresponding to an individual frame image included in the input video. The lidar data may correspond to the individual frame in that it may have been captured at effectively the same time as the individual frame image. Due to different sensor sampling rates or other factors, there may be more image frames than lidar images (point clouds). For example, more frame images may be collected than lidar data during the same time. The electronic device may estimate final depth maps for each of the frame images by using a trained depth estimation model. Accordingly, even at a time point at which lidar data does not exist, temporary supplementary depth maps may be obtained. Even if lidar point clouds are captured for each video image frame, it may be more efficient to generate synthetic depth data from some lidar point clouds. The final depth maps estimated through the depth estimation model are generally denser than lidar-based depth images. Thus, even at a time point at which the lidar data exists for a frame, spatially supplementary depth maps may be obtained for the frame.

The electronic device may use the input image (individual frame image) and one or more frame images adjacent to the input image to generate the final depth map that is to be associated with (that corresponds to) the input image. Although the example of the electric device using the input image for training is mainly described above, the examples are not limited thereto. The electronic device may train the depth estimation model (e.g., the depth estimation model 231 of FIG. 2) by using the input image and one or more frame images adjacent to the input image. In this case, a frame image adjacent to the input image may be a frame image having a frame distance less than or equal to a preset frame distance from the input image. The frame image may be an image corresponding to a time frame temporally subsequent to a time frame of the input image. For example, the preset frame distance may be 3 frames, but examples are not limited thereto.

For example, the electronic device may generate a first pseudo depth map by using the input image to propagate (expand/improve) the lidar data corresponding to the input image. The electronic device may train the depth estimation model by using a loss between (i) a temporary depth map (calculated by inputting the input image to the depth estimation model) and (ii) the first pseudo depth computed for the input image, and then updating the depth estimation model (e.g., with backpropagation) according to the loss. To refine the depth estimation model, the training of the depth estimation model for the input image may be repeated by again inputting the input image to the depth estimation model to generate another temporary depth map; a loss between the new temporary depth map and the first pseudo depth map may be used to again update the depth estimation model. This iterative refinement of the depth estimation model using the first image may be repeated until the loss is sufficiently small or a maximum number of iterations have been performed.

Then, the electronic device may additionally train the depth estimation model by using a second frame image adjacent to the input image (e.g., a next input/frame image). More specifically, the electronic device may generate a second pseudo depth map (as per FIG. 2) by using the second frame image to propagate lidar data corresponding to the second frame. The electronic device may further train the depth estimation model by using a loss between (i) a temporary depth map (calculated by inputting the second frame image to the depth estimation model) and the second pseudo depth map. In similar fashion as with the first input/frame image, the electronic device may repeatedly train the depth estimation model by repeatedly inputting the frame image to the depth estimation model and updating the model according to loss between temporary depth maps and the second pseudo depth map.

For reference, FIG. 5 is a diagram visually illustrating the accuracy of results estimated by the depth estimation model according to an embodiment. For example, the final depth maps estimated through the depth estimation model may be transformed into images 510 and 520, considering a camera tilt. The image 510 may be an image transformed from a final depth map output from the depth estimation model fine-tuned by using only a single-frame image (e.g., the input image). The image 520 may be an image transformed from a final depth map output from the depth estimation model fine-tuned by using a multi-frame image (e.g., frame images).

The images transformed, considering the camera tilt, from depth maps may further clearly display an error pixel corresponding to an inaccurate depth value of the depth maps. For example, because the accuracy of depth value estimation of the second final depth map is higher than that of the first final depth map, face shape is unnatural in a region 511 of the image 510, but the face shape is natural in a region 521 of the image 520.

In another example, the electronic device may generate the final depth map corresponding to a frame image adjacent to the input image by using the depth estimation model trained corresponding to the input image. The electronic device may fine-tune the depth estimation model based on a repeated input of the input image to the depth estimation model. The electronic device may input the frame image adjacent to the input image to the fine-tuned depth estimation model and may obtain output data of the depth estimation model as the final depth map corresponding to the frame image.

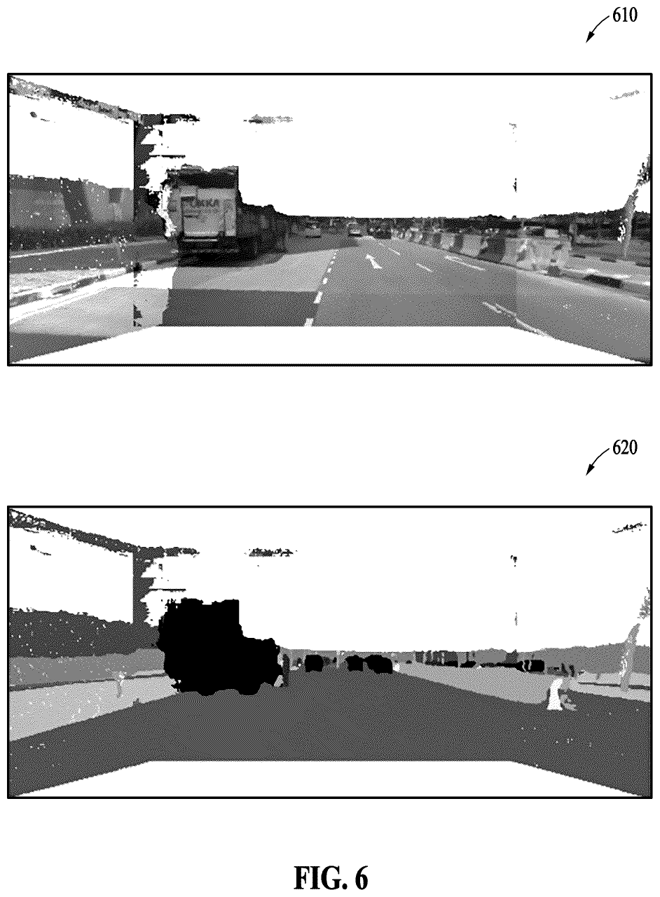

FIG. 6 illustrates an example of a process of generating point cloud information by using a final depth map corresponding to an input image by the electronic device according to one or more embodiments.

In an example, the electronic device may generate point cloud information 620 based on an input image 610 and the final depth map corresponding to the input image 610. For example, as illustrated in FIG. 6, the electronic device may display the point cloud information 620 in a form of positioning 3D points in a 3D space. More specifically, the electronic device may visually output, on a display (e.g., a 3D head-up display (HUD) or a head-mounted display (HMD) providing a stereoscopic vision), an output image (e.g., a stereoscopic image) generated by rendering the 3D points of the point cloud information 620. However, examples are not limited to the foregoing example. The electronic device may visually output, on a display (e.g., a 2D display), a 2D output image generated by projecting the 3D points onto an image plane corresponding to a random view.

In an example, the electronic device may obtain the final depth map corresponding to the input image 610 and camera parameters. In this case, the electronic device may transform 2D pixels included in the input image 610 into respective 3D points in a 3D space. The 3D space may be a space in a lidar coordinate system. The transformed 3D points in the 3D space may be the point cloud information 620 corresponding to the input image 610. For example, the electronic device may transform each pixel position of the input image 610 into coordinates in a camera coordinate system by using a camera's internal parameters (e.g., a focal distance and a principle point) among the camera parameters. The electronic device may transform the coordinates in the camera coordinate system into coordinates in the lidar coordinate system by using the camera's external parameters (e.g., a rotation matrix and a translation matrix) among the camera parameters. The camera's external parameters may be a transformation matrix that transforms the camera coordinate system into the lidar coordinate system. For example, data combining the input image 610 with the final depth map may be referred to as UV-D data, and the UV-D data may be data including a color value and depth value for each pixel position of an image coordinate system (e.g., a regularized image coordinate system). A camera-to-lidar matrix may be a matrix that transforms each pixel position of the UV-D data into 3D coordinates (e.g., XYZ coordinates) in the lidar coordinate system. Accordingly, the electronic device may generate the point cloud information 620. The point cloud information 620 may include a 3D point (e.g., a point having the 3D coordinates) for each pixel determined through the coordinate transformation described above. The electronic device may generate the point cloud information 620 of the same space as that of lidar data by applying the matrix to the input image 610 and the final depth map corresponding to the input image 610. In other words, a point cloud by the lidar data and the point cloud information 620 obtained from the input image 610 and the final depth map may be expressed by the same lidar coordinate system.

For example, the electronic device may output, on a display, each 3D point of the point cloud information 620 as a color value of a corresponding pixel in the input image 610. In this case, the objects and background of the input image 610 may be visualized in three dimensions.

In addition, the electronic device may generate a semantic segmentation image by performing semantic segmentation on the input image 610 and may identify a class into which an individual pixel included in the input image 610 is classified through the semantic segmentation image. In this case, when transforming the pixels included in the input image 610 respectively into the 3D points in the 3D space, a class of a 3D point may be determined to be the same class as a class of a 2D pixel. As illustrated in FIG. 6, when displaying the point cloud information 620 in the form of positioning the 3D points in the 3D space, the electronic device may display a class classified by each 3D point in a different color. For example, the electronic device may output, on a display, each 3D point of the point cloud information 620 as a label value (e.g., a label value indicating an object or the background segmented in the semantic segmentation image) of a corresponding pixel in the semantic segmentation image. A unique color value may be mapped to each label value. The electronic device may visualize individual 3D points in three dimensions with color values respectively mapped to label values.

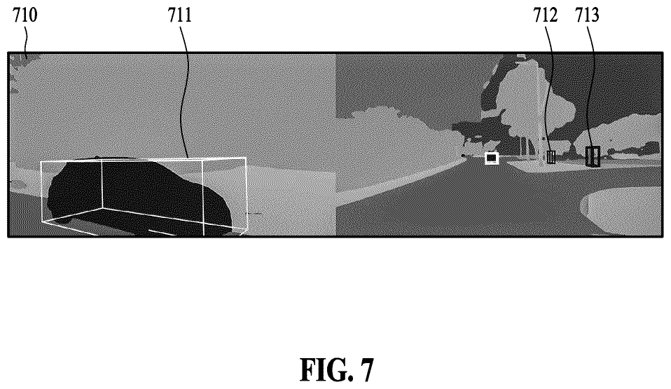

FIG. 7 illustrates an example of a process of performing object detection by using point cloud information by the electronic device according to one or more embodiments.

In an example, the electronic device may perform object detection by using point cloud information 710 (e.g., the point cloud information 610 of FIG. 6). Although typical lidar data only includes limited information on 3D points, the point cloud information 710 may include more information of points. Accordingly, it is more advantageous for the electronic device to perform object detection by using the point cloud information 710 instead of the typical lidar data. In addition, a lidar may hardly detect 3D points of an object in the distance greater than or equal to a certain distance from the lidar due to the physical property of the lidar, but the point cloud information 710 may include information on far away points. Thus, it is more advantageous to perform object detection by using the point cloud information 710. Referring to FIG. 7, the electronic device may detect a plurality of objects 711, 712, and 713 from the point cloud information 710.

The computing apparatuses, the electronic devices, the processors, the memories, the sensors, the displays, the information output system and hardware, the storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An electronic device comprising:
one or more processors; and
memory storing instructions configured to cause the one or more processors to:
process an input image and point cloud data corresponding to the input image;
generate a first depth map by projecting the point cloud and determining some depth values of first depth map based on the input image;
obtain a second depth map by inputting the input image to a depth estimation model configured to generate depth maps from images;
train the depth estimation model based on a loss between the first depth map and the second depth map; and
generate a final depth map corresponding to the input image through the trained depth estimation model.

2. The electronic device of claim 1, wherein the instructions are further configured to cause the one or more processors to generate the first depth map by projecting the cloud data to form a depth image and transform the depth image to the first depth map based on the input image.

3. The electronic device of claim 2, wherein the instructions are further configured to cause the one or more processors to transform the depth image to the first depth map by applying a first image filter based on the input image to the depth image.

4. The electronic device of claim 2, wherein the instructions are further configured to cause the one or more processors to generate a semantic segmentation image by performing semantic segmentation on the input image, and transform the depth image to the first depth map by applying a second image filter based on the semantic segmentation image to the depth image.

5. The electronic device of claim 1, wherein the instructions are further configured to cause the one or more processors to calculate the loss based on differences between depth values of pixels in the first depth map and depth values of corresponding pixels in the second depth map and update a parameter of the depth estimation model by backpropagating the calculated loss from an output layer of the depth estimation model to an input layer of the depth estimation model.

6. The electronic device of claim 1, wherein the instructions are further configured to cause the one or more processors to repeatedly update the parameter of the depth estimation model based on repeated inputting of the input image to the depth estimation model.

7. The electronic device of claim 6, wherein the repeated inputting is performed until it is determined that a corresponding loss between the first depth map and second depth map obtained by the repeated inputting of the input image to the depth estimation model is less than a threshold loss.

8. The electronic device of claim 6, wherein the repeated inputting of the input image to the depth estimation model is terminated based on the repeated inputting reaching a preset iteration limit.

9. The electronic device of claim 1, wherein the instructions are further configured to cause the one or more processors to train the depth estimation model by using the input image and one or more frame images adjacent to the input image within a video segment.

10. The electronic device of claim 1, wherein the instructions are further configured to cause the one or more processors to generate point cloud information based on the input image and the final depth map corresponding to the input image and perform object detection by using the generated point cloud information.

11. A method performed by one or more processors of an electronic device, the method comprising:
processing an input image and point cloud data corresponding to the input image;
projecting the point cloud data to generate a first depth map and adding new depth values to the first depth map based on the input image;
obtaining a second depth map by inputting the input image to a depth estimation model configured to infer depth maps from input images; and
training the depth estimation model based on a loss difference between the first depth map and the second depth map.

12. The method of claim 11, wherein the added depth values are computed based on color values of the input image.

13. The method of claim 12, further comprising:
applying a first image filter based on the input image to the first depth map.

14. The method of claim 12, wherein the generating the first depth map further comprises:
generating a semantic segmentation image by performing semantic segmentation on the input image; and
forming the first depth map by applying a second image filter based on the semantic segmentation image to the first depth map.

15. The method of claim 11, wherein the training the depth estimation model comprises:
calculating the loss difference based on a difference between a depth value of a pixel in the first depth map and a depth value of a corresponding pixel in the second depth map; and
updating a parameter of the depth estimation model based on the difference.

16. The method of claim 11, wherein the training the depth estimation model comprises:
repeatedly updating parameters of the depth estimation model based on repeated inputting of the input image to the depth estimation model.

17. The method of claim 16, wherein the repeated updating of the parameter of the depth estimation model is terminated based on determining that a loss between the temporary depth map obtained by the repeated inputting the input image to the depth estimation model and the first depth map is less than a threshold loss.

18. The method of claim 16, wherein the repeated updating of the parameters of the depth estimation model is terminated based on the repeated inputting of the input image to the depth estimation model being performed a preset number of times.

19. The method of claim 11, further comprising:
training the depth estimation model by using the input image and one or more frame images adjacent to the input image in a video segment.

20. The method of claim 11, further comprising:
generating point cloud information based on the input image and the final depth map corresponding to the input image and performing object detection by using the generated point cloud information.
